(19) United States
(12) Patent Application Publication
(10) Pub. No.: US 2024/0369445 A1
(43) Pub. Date: Nov. 7, 2024

(54) Eight-Drive Six-Degrees-of-Freedom Electrodynamic Vibration Testing Apparatus Having Adjustable Spatial Pose

(71) Applicants: ETS SOLUTIONS (BEIJING) LTD., Beijing (CN); BEIJING INSTITUTE OF STRUCTURE AND ENVIRONMENT ENGINEERING, Beijing (CN)

(72) Inventors: Jun LIU, Beijing (CN); Kejie SONG, Beijing (CN); Kuihua ZHANG, Beijing (CN); Xiaobo CAO, Beijing (CN); Shujie XIA, Beijing (CN); Yang LI, Beijing (CN); Hongyan DI, Beijing (CN); Lifeng XU, Beijing (CN)

(21) Appl. No.: 18/572,812

(22) PCT Filed: Jul. 22, 2022
(86) PCT No.: PCT/CN2022/107362

§ 371 Date: Dec. 21, 2023

(30) Foreign Application Priority Data
Aug. 3, 2021 (CN) 202110886498.6

(51) Int. Cl. G01M 7/06

(52) U.S. Cl. CPC G01M 7/06

(57) ABSTRACT

Disclosed is an eight-drive six-degrees-of-freedom electrodynamic vibration testing apparatus having an adjustable spatial pose, which includes a pedestal center base. Four corners of a square cavity above the pedestal center base are sequentially provided with a fifth shaker, a sixth shaker, a seventh shaker, and an eighth shaker. A first pedestal side base is fixedly connected to a side wall of the pedestal center base. The pedestal center base, the pedestal side bases, and corner connecting bases are designed in a manner of split combination and annular connection, thereby reducing the difficulty in overall transportation, processing and installation; moreover, by using an annular fastening structure, high resonance frequency is achieved, low-frequency resonance of the apparatus is effectively reduced.

### CROSS-REFERENCE TO RELATED APPLICATION

The disclosure is a National Stage Filing of the PCT International Application No: PCT/CN2022/107362 filed on 22 Jul. 2022, which claims priority to and the benefit of Chinese Patent Application No. 202110886498.6, filed to the China National Intellectual Property Administration (CHIPA) on 3 Aug. 2021, which is hereby incorporated by reference in its entirety.

### TECHNICAL FIELD

The disclosure relates to the technical field of vibration environment testing devices, and in particular to an eight-drive six-degrees-of-freedom electrodynamic vibration testing apparatus having an adjustable spatial pose.

### BACKGROUND

Vibration is one of the main factors causing faults in aerospace and transportation devices. However, products are actually in a multi-dimensional vibration environment and are limited by the capabilities of testing devices, unidirectional vibration tests are respectively performed in traditional test methods, but a fault mechanism of some military devices is unique to a multi-axis environment, so that the unidirectional vibration tests cannot reproduce multi-dimensional vibration response faults thereof. Certain military products, such as inertial measurement assemblies, aerospace engines, nose fuses, communication devices, and vehicle power supplies, have an extremely high demand for multi-axis vibration tests.

A multi-axis vibration testing apparatus, especially a six-degrees-of-freedom vibration testing apparatus, has a significant demand, mainly manifested as follows: firstly, the limitations of traditional vibration testing methods become more prominent, mainly reflected in some devices (such as the vehicle power supplies, communication devices, and nose fuses) that have already passed the single-axis tests according to the standard cannot withstand the multi-dimensional vibration environment in the external field (transportation) or use (flight) environment, and multi-axis vibration environment tests reveal potential faults that the single-axis tests fail to discover. Secondly, asymmetrical loads are applied to satellites, spacecraft, and aerospace planes by some carrier rockets, and in order to further reduce structural weight, it is necessary to simulate these multi-dimensional loads realistically. Thirdly, the successful application of an inertial measurement combination needs to rely on the multi-dimensional vibration tests. Fourthly, when high-thrust vibration tests are performed on heavy weapons, large carrier rockets, satellites, and space stations, if the thrust of a single shaker cannot meet the requirements, it is necessary to perform joint excitation tests using multiple shakers.

At present, the existing three-axis six-degrees-of-freedom vibration testing apparatuses are mostly implemented using eight hydrostatic shakers. However, these apparatuses have the defects of low vibration frequency and large waveform distortion due to the use of the hydrostatic shakers as excitation sources. Six-degrees-of-freedom vibration test systems are also implemented using eight electrodynamic shakers due to the fact that motion components of the electrodynamic shakers control a pose of a working platform only through air springs inside the shakers, and the air springs may only provide driving forces but not pulling forces. Therefore, in all previous eight-drive six-degrees-of-freedom electrodynamic shaker systems, the spatial pose of the working platform cannot be arbitrarily controlled and adjusted. As a result, the working platform often deviates from the balanced position, for example, a linear displacement direction deviates by a certain distance, or has a certain inclination angle, which easily leads to test failures or damage to the devices or test pieces when the device operates at an extreme position.

To this end, an eight-drive six-degrees-of-freedom electrodynamic vibration testing apparatus having an adjustable spatial pose is developed. Through the design of a supplementary coupling assembly, the working platform has twelve driving forces to control the spatial pose of the platform.

### SUMMARY

The disclosure aims to provide an eight-drive and six-degrees-of-freedom electrodynamic vibration testing apparatus having an adjustable spatial pose, so as to solve the problems proposed in the above Background.

In order to achieve the above objective, the disclosure provides the following technical solution.

Some embodiments of the disclosure provide an eight-drive six-degrees-of-freedom electrodynamic vibration testing apparatus having an adjustable spatial pose, which includes a pedestal center base, four corners of a square cavity above the pedestal center base are sequentially provided with a fifth shaker, a sixth shaker, a seventh shaker, and an eighth shaker, a first pedestal side base is fixedly connected to a side wall of the pedestal center base, a second pedestal side base is fixedly connected to a side wall, adjacent to the first pedestal side base, of the pedestal center base, a fourth pedestal side base is fixedly connected to the other side wall, adjacent to the first pedestal side base, of the pedestal center base, a third pedestal side base is fixedly connected to a side wall, opposite to the first pedestal side base, of the pedestal center base, the first pedestal side base, the second pedestal side base, the third pedestal side base, and the fourth pedestal side base are all of square structures, a right-angle position, adjacent to the second pedestal side base, of the first pedestal side base is connected to a first corner connecting base through screws, a right-angle position, adjacent to the third pedestal side base, of the second pedestal side base is connected to a second corner connecting base through screws, a right-angle position, adjacent to the fourth pedestal side base, of the third pedestal side base is connected to a third corner connecting base through screws, a right-angle position, adjacent to the first pedestal side base, of the fourth pedestal side base is connected to a fourth corner connecting base through screws.

In some embodiments, vibration isolation apparatuses are installed on both sides of the bottom of each of the first pedestal side base, the second pedestal side base, the third pedestal side base, and the fourth pedestal side base through screws, and the vibration isolation apparatuses are vibration isolation air springs.

In some embodiments, a fourth shaker is fixedly installed on one side above the first pedestal side base through a fixed base, and a fourth supplementary coupling assembly is fixedly installed on one side, located on the fourth shaker, of the first pedestal side base through a mounting pedestal; a third shaker is fixedly installed on one side above the second pedestal side base through a fixed base, and a third supplementary coupling assembly is fixedly installed on one side, located on the third shaker, of the second pedestal side base through a mounting pedestal; a second shaker is fixedly installed on one side above the third pedestal side base through a fixed base, and a second supplementary coupling assembly is fixedly installed on one side, located on the second shaker, of the third pedestal side base through a mounting pedestal; a first shaker is fixedly installed on one side above the fourth pedestal side base through a fixed base, and a first supplementary coupling assembly is fixedly installed on one side, located on the first shaker, of the fourth pedestal side base through a mounting pedestal.

In some embodiments, an output end of the first supplementary coupling assembly is connected to an eighth double-spherical-coupling decoupling apparatus, and an output end of the first shaker is connected to a first double-spherical-coupling decoupling apparatus; an output end of the second supplementary coupling assembly is fixedly connected to a second double-spherical-coupling decoupling apparatus, and an output end of the second shaker is connected to a third double-spherical-coupling decoupling apparatus; an output end of the third supplementary coupling assembly is connected to a fourth double-spherical-coupling decoupling apparatus, and an output end of the third shaker is connected to a fifth double-spherical-coupling decoupling apparatus; an output end of the fourth supplementary coupling assembly is fixedly connected to a sixth double-spherical-coupling decoupling apparatus, and an output end of the fourth shaker is connected to a seventh double-spherical-coupling decoupling apparatus.

In some embodiments, an output end of the fifth shaker is connected to a ninth double-spherical-coupling decoupling apparatus, an output end of the sixth shaker is connected to a tenth double-spherical-coupling decoupling apparatus, an output end of the seventh shaker is connected to an eleventh double-spherical-coupling decoupling apparatus, and an output end of the eighth shaker is connected to a twelfth double-spherical-coupling decoupling apparatus.

In some embodiments, a working platform is fixed among the first double-spherical-coupling decoupling apparatus, the second double-spherical-coupling decoupling apparatus, the third double-spherical-coupling decoupling apparatus, the fourth double-spherical-coupling decoupling apparatus, the fifth double-spherical-coupling decoupling apparatus, the sixth double-spherical-coupling decoupling apparatus, the seventh double-spherical-coupling decoupling apparatus, the eighth double-spherical-coupling decoupling apparatus, the ninth double-spherical-coupling decoupling apparatus, the tenth double-spherical-coupling decoupling apparatus, the eleventh double-spherical-coupling decoupling apparatus, and the twelfth double-spherical-coupling decoupling apparatus through a double hydrostatic spherical-coupling base.

In some embodiments, the double hydrostatic spherical-coupling base includes a spherical-coupling base body, a first movable body movably installed inside the spherical-coupling base body, and a second movable body movably installed inside the spherical-coupling base body.

In some embodiments, each of the first supplementary coupling assembly, the second supplementary coupling assembly, the third supplementary coupling assembly, and the fourth supplementary coupling assembly includes a supplementary coupling assembly drive airbag, a supplementary coupling assembly bearing seat, a supplementary coupling assembly guide bearing, a supplementary coupling assembly guide bearing cover, a supplementary coupling assembly guide shaft, and a supplementary coupling assembly connecting flange.

In some embodiments, the supplementary coupling assembly guide shaft is slidably connected to the supplementary coupling assembly guide bearing, the supplementary coupling assembly guide bearing and the supplementary coupling assembly guide bearing seat are fixedly installed through the supplementary coupling assembly guide bearing cover, and the supplementary coupling assembly connecting flange is fixedly welded to the supplementary coupling assembly guide shaft.

Compared with the related art, the disclosure has the following beneficial effects.

In the disclosure, the pedestal center base, the pedestal side bases, and the corner connecting bases are designed in a manner of split combination and annular connection, thereby reducing the difficulty in overall transportation, processing and installation, moreover, by using an annular fastening structure, high resonance frequency is achieved, low-frequency resonance of the apparatus is effectively reduced, a supplementary coupling assembly is used, spatial pose control is performed on a working platform, so that the platform is at a static and dynamic alignment position, thereby avoiding over-displacement faults or test failures caused by zero offsets of the shakers, the six-degrees-of-freedom shaker is driven by the electrodynamic shakers, and thus has the advantages of wide vibration frequency and small waveform distortion.

### BRIEF DESCRIPTION OF THE DRAWINGS

FIG. 1 is a schematic structural diagram of the disclosure.

FIG. 2 is a schematic structural diagram of a pedestal center base in the disclosure.

FIG. 3 is a schematic structural diagram of a fifth shaker in the disclosure.

FIG. 4 is an exploded view of a pedestal center base in the disclosure.

FIG. 5 is a section view of a double hydrostatic spherical-coupling base in the disclosure.

FIG. 6 is a section view of a supplementary coupling assembly in the disclosure.

FIG. 7 is a bottom view of a pedestal center base in the disclosure.

In the figures: 1. First shaker; 2. Second shaker; 3. Third shaker; 4. Fourth shaker; 5. Fifth shaker; 6. Sixth shaker; 7. Seventh shaker; 8. Eighth shaker; 9. First double-spherical-coupling decoupling apparatus; 10. Second double-spherical-coupling decoupling apparatus; 11. Third double-spherical-coupling decoupling apparatus; 12. Fourth double-spherical-coupling decoupling apparatus; 13. Fifth double-spherical-coupling decoupling apparatus; 14. Sixth double-spherical-coupling decoupling apparatus; 15. Seventh double-spherical-coupling decoupling apparatus; 16. Eighth double-spherical-coupling decoupling apparatus; 17. Ninth double-spherical-coupling decoupling apparatus; 18. Tenth double-spherical-coupling decoupling apparatus; 19. Eleventh double-spherical-coupling decoupling apparatus; 20. Twelfth double-spherical-coupling decoupling apparatus; 21. Working platform; 22. Pedestal center base; 23. First pedestal side base; 24. Second pedestal side base; 25. Third pedestal side base; 26. Fourth pedestal side base; 27. First corner connecting seat; 28. Second corner connecting seat; 29. Third corner connecting seat; 30. Fourth corner connecting seat; 31. First supplementary coupling assembly; 32. Second supplementary coupling assembly; 33. Third supplementary coupling assembly; 34. Fourth supplementary coupling assembly; 35. Vibration isolation apparatus; 36. Supplementary coupling assembly drive airbag; 37. Supplementary coupling assembly bearing seat; 38. Supplementary coupling assembly guide bearing; 39. Supplementary coupling assembly guide bearing cover; 40. Supplementary coupling assembly guide shaft; 41. Supplementary coupling assembly connecting flange; 42. First movable body; 43. Spherical-coupling base body; 44. Second movable body.

### DETAILED DESCRIPTION OF THE EMBODIMENTS

The technical solutions in the embodiments of the disclosure will be clearly and completely described in conjunction with the drawings in the embodiments of the disclosure. It is apparent that the described embodiments are only a part of the embodiments of the disclosure, and not all of them. All other embodiments obtained by those of ordinary skill in the art based on the embodiments of the disclosure without creative efforts are within the scope of the disclosure.

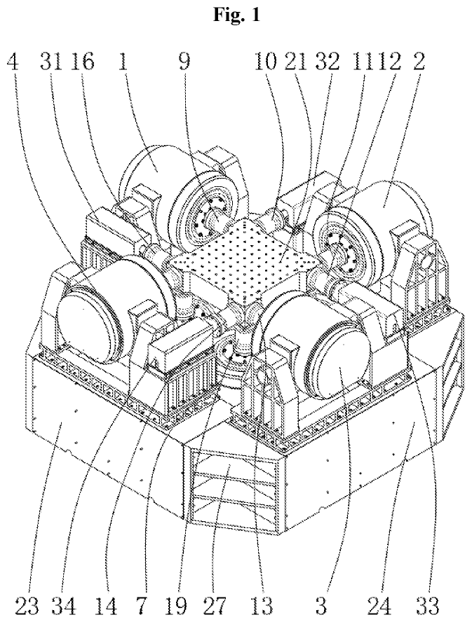

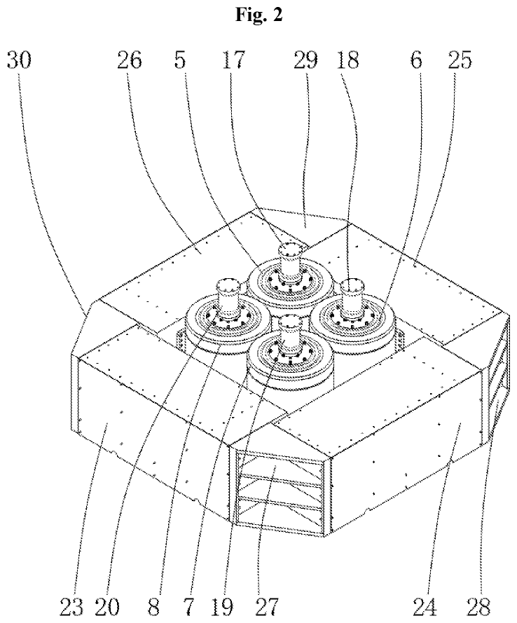

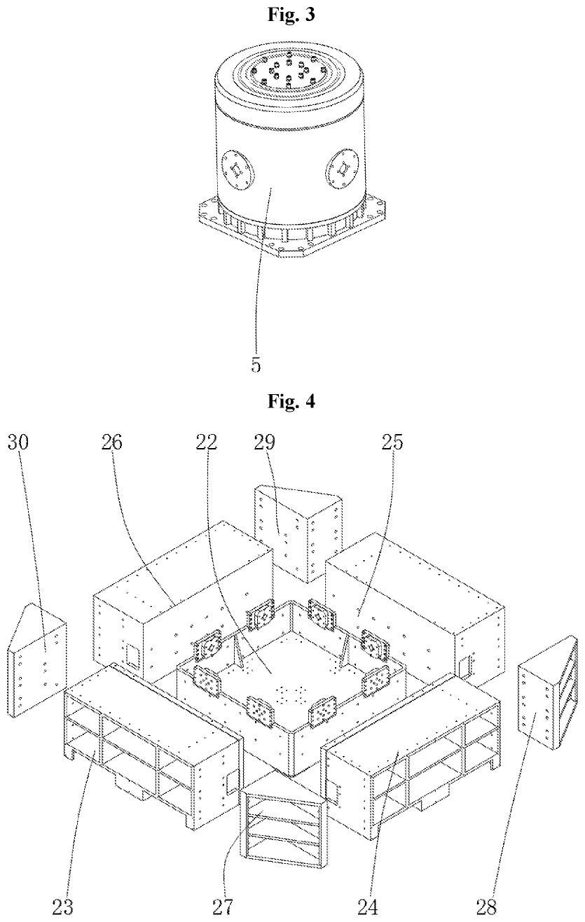

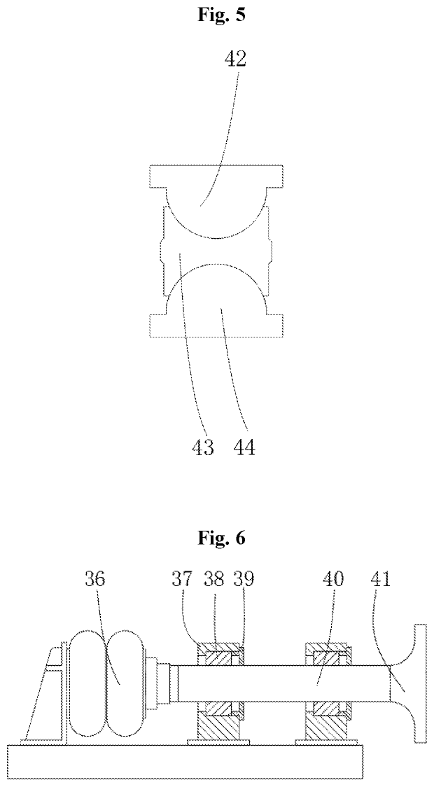

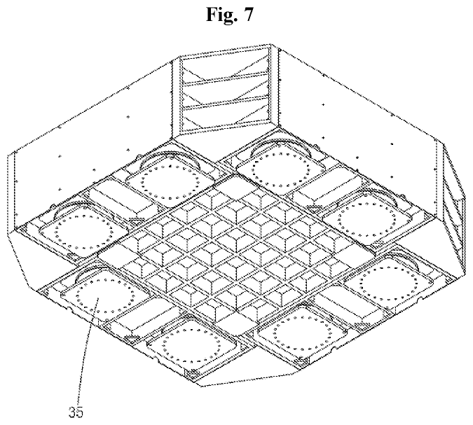

Referring to FIGS. 1-7, some embodiments of the disclosure provide an eight-drive six-degrees-of-freedom electrodynamic vibration testing apparatus having an adjustable spatial pose, which includes a pedestal center base 22, four corners of a square cavity above the pedestal center base 22 are sequentially provided with a fifth shaker 5, a sixth shaker 6, a seventh shaker 7, and an eighth shaker 8, a first pedestal side base 23 is fixedly connected to a side wall of the pedestal center base 22, a second pedestal side base 24 is fixedly connected to a side wall, adjacent to the first pedestal side base 23, of the pedestal center base 22, a fourth pedestal side base 26 is fixedly connected to the other side wall, adjacent to the first pedestal side base 23, of the pedestal center base 22, a third pedestal side base 25 is fixedly connected to a side wall, opposite to the first pedestal side base 23, of the pedestal center base 22, the first pedestal side base 23, the second pedestal side base 24, the third pedestal side base 25, and the fourth pedestal side base 26 are all of square structures, a right-angle position, adjacent to the second pedestal side base 24, of the first pedestal side base 23 is connected to a first corner connecting base 27 through screws, a right-angle position, adjacent to the third pedestal side base 25, of the second pedestal side base 24 is connected to a second corner connecting base 28 through screws, a right-angle position, adjacent to the fourth pedestal side base 26, of the third pedestal side base 25 is connected to a third corner connecting base 29 through screws, a right-angle position, adjacent to the first pedestal side base 23, of the fourth pedestal side base 26 is connected to a fourth corner connecting base 30 through screws.

The pedestal center base 22, the pedestal side bases, and corner connecting bases are designed in a manner of split combination and annular connection, thereby reducing the difficulty in overall transportation, processing and installation, moreover, by using an annular fastening structure, high resonance frequency is achieved, and low-frequency resonance of the apparatus is effectively reduced. The fifth shaker 5, the sixth shaker 6, the seventh shaker 7, and the eighth shaker 8 vibrate at the same frequency and in the same phase at the same time, so that a linear vibration of a working platform 21 in a vertical z direction is achieved, and the fifth shaker 5 and the sixth shaker 6, as well as the seventh shaker 7 and the eighth shaker 8 vibrate at the same frequency and in inverse phase at the same time, so that an angular vibration around an x axis is achieved; the fifth shaker 5 and the eighth shaker 8, as well as the sixth shaker 6 and the seventh shaker 7 vibrate at the same frequency and in inverse phase at the same time, so that an angular vibration around a y axis is achieved.

In some embodiments, vibration isolation apparatuses 35 are installed on both sides of the bottom of each of the first pedestal side base 23, the second pedestal side base 24, the third pedestal side base 25, and the fourth pedestal side base 26 through screws, and the vibration isolation apparatuses 35 are vibration isolation air springs. The vibration isolation air springs are configured to isolate the influence of the vibration generated by the apparatus on a test site.

In some embodiments, a fourth shaker 4 is fixedly installed on one side above the first pedestal side base 23 through a fixed base, and a fourth supplementary coupling assembly 34 is fixedly installed on one side, located on the fourth shaker 4, of the first pedestal side base 23 through a mounting pedestal; a third shaker 3 is fixedly installed on one side above the second pedestal side base 24 through a fixed base, and a third supplementary coupling assembly 33 is fixedly installed on one side, located on the third shaker 3, of the second pedestal side base 24 through a mounting pedestal; a second shaker 2 is fixedly installed on one side above the third pedestal side base 25 through a fixed base, and a second supplementary coupling assembly 32 is fixedly installed on one side, located on the second shaker 2, of the third pedestal side base 25 through a mounting pedestal; a first shaker 1 is fixedly installed on one side above the fourth pedestal side base 26 through a fixed base, and a first supplementary coupling assembly 31 is fixedly installed on one side, located on the first shaker 1, of the fourth pedestal side base 26 through a mounting pedestal.

The first shaker 1 and the third shaker 3 vibrate at the same frequency and in the same phase at the same time, so that the linear vibration of the working platform 21 is achieved along the x axis; the second shaker 2 and the fourth shaker 4 vibrate at the same frequency and in the same phase at the same time, so that the linear vibration of the working platform 21 is achieved along the y axis; the four shakers arranged in the vertical direction are connected to a cavity of a table surface of the pedestal center base 22, so that the outer envelope size of the shaker is reduced, at the same time, the vibration transmission rigidity of the vertical shaker is improved through the design.

In some embodiments, an output end of the first supplementary coupling assembly 31 is connected to an eighth double-spherical-coupling decoupling apparatus 16, and an output end of the first shaker 1 is connected to a first double-spherical-coupling decoupling apparatus 9; an output end of the second supplementary coupling assembly 32 is fixedly connected to a second double-spherical-coupling decoupling apparatus 10, and an output end of the second shaker 2 is connected to a third double-spherical-coupling decoupling apparatus 11; an output end of the third supplementary coupling assembly 33 is connected to a fourth double-spherical-coupling decoupling apparatus 12, and an output end of the third shaker 3 is connected to a fifth double-spherical-coupling decoupling apparatus 13; an output end of the fourth supplementary coupling assembly 34 is fixedly connected to a sixth double-spherical-coupling decoupling apparatus 14, and an output end of the fourth shaker 4 is connected to a seventh double-spherical-coupling decoupling apparatus 15.

In some embodiments, an output end of the fifth shaker 5 is connected to a ninth double-spherical-coupling decoupling apparatus 17, an output end of the sixth shaker 6 is connected to a tenth double-spherical-coupling decoupling apparatus 18, an output end of the seventh shaker 7 is connected to an eleventh double-spherical-coupling decoupling apparatus 19, and an output end of the eighth shaker 8 is connected to a twelfth double-spherical-coupling decoupling apparatus 20.

In some embodiments, the working platform 21 is fixed among the first double-spherical-coupling decoupling apparatus 9, the second double-spherical-coupling decoupling apparatus 10, the third double-spherical-coupling decoupling apparatus 11, the fourth double-spherical-coupling decoupling apparatus 12 the fifth double-spherical-coupling decoupling apparatus 13, the sixth double-spherical-coupling decoupling apparatus 14, the seventh double-spherical-coupling decoupling apparatus 15, the eighth double-spherical-coupling decoupling apparatus 16, the ninth double-spherical-coupling decoupling apparatus 17, the tenth double-spherical-coupling decoupling apparatus 18, the eleventh double-spherical-coupling decoupling apparatus 19, and the twelfth double-spherical-coupling decoupling apparatus 20 through a double hydrostatic spherical-coupling base.

In some embodiments, the double hydrostatic spherical-coupling base includes a spherical-coupling base body 43, a first movable body 42 movably installed inside the spherical-coupling base body 43, and a second movable body 44 movably installed inside the spherical-coupling base body 43.

In some embodiments, each of the first supplementary coupling assembly 31, the second supplementary coupling assembly 32, the third supplementary coupling assembly 33, and the fourth supplementary coupling assembly 34 includes a supplementary coupling assembly drive airbag 36, a supplementary coupling assembly bearing seat 37, a supplementary coupling assembly guide bearing 38, a supplementary coupling assembly guide bearing cover 39, a supplementary coupling assembly guide shaft 40, and a supplementary coupling assembly connecting flange 41.

In some embodiments, the supplementary coupling assembly guide shaft 40 is slidably connected to the supplementary coupling assembly guide bearing 38, the supplementary coupling assembly guide bearing 38 and the supplementary coupling assembly guide bearing seat 37 are fixedly installed through the supplementary coupling assembly guide bearing cover 39, and the supplementary coupling assembly connecting flange 41 is fixedly welded to the supplementary coupling assembly guide shaft 40.

The role of the supplementary coupling assembly drive airbag 36 is to provide a driving force for position adjustment of the platform, the role of the supplementary coupling assembly guide bearing 38 is to provide the guiding stiffness for position adjustment, the arrangement of two supplementary coupling assembly guide bearings 38 is able to provide a moment resistant to bending, twelve air springs are inflated to provide the forward driving force and are deflated to reduce the forward driving force, and the linear displacement and angular displacement of the working platform 21 are adjusted by coordinating inflation and deflation of twelve air springs.

In the embodiment, by using the supplementary coupling assembly, spatial pose control is performed on the working platform 21, so that the platform is at a static and dynamic alignment position, thereby avoiding over-displacement faults or test failures caused by zero offsets of the shakers.

In the embodiment, the six-degrees-of-freedom shaker is driven by the electrodynamic shakers, and thus has the advantages of wide vibration frequency and small waveform distortion.

In the embodiment, the double-spherical-coupling decoupling apparatus is a hydrostatic lubrication decoupling apparatus or a mechanical lubrication decoupling apparatus, and is also replaced with a spherical-planar decoupling apparatus. The shaker is an electrodynamic shaker or a hydrostatic shaker and a mechanical shaker according to a resonant source. The vibration isolation air springs at the bottom are able to be replaced in the form of integral foundation vibration isolation. There is other numbers, such as one, two or more, of the supplementary coupling assembly guide bearings 38. The supplementary coupling assembly guide bearing 38 is in various forms, such as a linear ball bearing, a self-lubricating linear bearing or a static pressure linear bearing.

A manner of achieving a three-axis linear vibration in the embodiment is as follows: the first shaker 1 and the third shaker 3 on the x axis are controlled to vibrate according to a specified vibration waveform, and the vibration control of the first shaker 1 and the third shaker 3 requires the same frequency and phase at the same time; the second shaker 2 and the fourth shaker 4 on the y axis are controlled to vibrate according to a specified vibration waveform, and the vibration control of the second shaker 2 and the fourth shaker 4 requires the same frequency and phase at the same time; and the fifth shaker 5, the sixth shaker 6, the seventh shaker 7, and the eighth shaker 8 on the z axis are controlled to vibrate according to a specified vibration waveform, and the vibration control of the fifth shaker 5, the sixth shaker 6, the seventh shaker 7, and the eighth shaker 8 requires the same frequency and phase at the same time. In this way, the linear vibrations of x, y, and z axes are synthesized into a spatial three-axis linear vibration at the working platform 21.

A manner of achieving a three-axis angular vibration in the embodiment is as follows: the first shaker 1 and the third shaker 3 are controlled to vibrate according to the specified vibration waveform, and the vibration control of the first shaker 1 and the third shaker 3 requires the same frequency and phase at the same time, thereby forming an angular vibration around the z axis; the second shaker 2 and the fourth shaker 4 are controlled to vibrate according to the specified vibration waveform, and the vibration control of the second shaker 2 and the fourth shaker 4 requires the same frequency and phase at the same time, thereby forming an angular vibration around the z axis; the fifth shaker 5 and the eighth shaker 8 are controlled to vibrate according to the specified vibration waveform, and the vibration control of the fifth shaker 5 and the eighth shaker 8 requires the same frequency and phase at the same time, and meanwhile, the sixth shaker 6 and the seventh shaker 7 are controlled to vibrate according to a specified vibration waveform, and the vibration control of the fifth shaker 5 and the eighth shaker 8 requires the same frequency and inverse phase at the same time, thereby forming an angular vibration around the y axis; or the fifth shaker 5 and the sixth shaker 6 are controlled to vibrate according to a specified vibration waveform, and the vibration control of the fifth shaker 5 and the sixth shaker 6 requires the same frequency and phase at the same time, and meanwhile, the seventh shaker 7 and the eighth shaker 8 are controlled to vibrate according to a specified vibration waveform, and the vibration control of the fifth shaker 5 and the eighth shaker 8 requires the same frequency and inverse phase at the same time, thereby forming an angular vibration around the x axis. In this way, the angular vibrations of x, y, and z axes are synthesized into a spatial three-axis angular vibration at the working platform 21.

A manner of partial six-degrees-of-freedom in the embodiment is as follows: the vibration conditions of the above spatial linear vibration and the spatial angular vibration are superimposed to form a six-degrees-of-freedom vibration including the linear vibration and the angular vibration.

The above is only the specific embodiments of the disclosure and not intended to limit the scope of protection of the disclosure. Any equivalent replacement or change made by those skilled in the art according to the technical solutions and the conception within the technical scope disclosed by the disclosure shall fall within the scope of protection of the disclosure.

What is claimed is:

1. An eight-drive six-degrees-of-freedom electrodynamic vibration testing apparatus having an adjustable spatial pose, comprising a pedestal center base, four corners of a square cavity above the pedestal center base are sequentially provided with a fifth shaker, a sixth shaker, a seventh shaker, and an eighth shaker; a first pedestal side base is fixedly connected to a side wall of the pedestal center base; a second pedestal side base is fixedly connected to a side wall, adjacent to the first pedestal side base, of the pedestal center base; a fourth pedestal side base is fixedly connected to the other side wall, adjacent to the first pedestal side base, of the pedestal center base; a third pedestal side base is fixedly connected to a side wall, opposite to the first pedestal side base, of the pedestal center base; the first pedestal side base, the second pedestal side base, the third pedestal side base, and the fourth pedestal side base are all of square structures; a right-angle position, adjacent to the second pedestal side base, of the first pedestal side base is connected to a first corner connecting base through screws; a right-angle position, adjacent to the third pedestal side base, of the second pedestal side base is connected to a second corner connecting base through screws; a right-angle position, adjacent to the fourth pedestal side base, of the third pedestal side base is connected to a third corner connecting base through screws; and a right-angle position, adjacent to the first pedestal side base, of the fourth pedestal side base is connected to a fourth corner connecting base through screws.

2. The eight-drive six-degrees-of-freedom electrodynamic vibration testing apparatus having the adjustable spatial pose according to claim 1, wherein vibration isolation apparatuses are installed on both sides of the bottom of each of the first pedestal side base, the second pedestal side base, the third pedestal side base, and the fourth pedestal side base through screws, and the vibration isolation apparatuses are vibration isolation air springs.

3. The eight-drive six-degrees-of-freedom electrodynamic vibration testing apparatus having the adjustable spatial pose according to claim 1, wherein a fourth shaker is fixedly installed on one side above the first pedestal side base through a fixed base, and a fourth supplementary coupling assembly is fixedly installed on one side, located on the fourth shaker, of the first pedestal side base through a mounting pedestal; a third shaker is fixedly installed on one side above the second pedestal side base through a fixed base, and a third supplementary coupling assembly is fixedly installed on one side, located on the third shaker, of the second pedestal side base through a mounting pedestal; a second shaker is fixedly installed on one side above the third pedestal side base through a fixed base, and a second supplementary coupling assembly is fixedly installed on one side, located on the second shaker, of the third pedestal side base through a mounting pedestal; and a first shaker is fixedly installed on one side above the fourth pedestal side base through a fixed base, and a first supplementary coupling assembly is fixedly installed on one side, located on the first shaker, of the fourth pedestal side base through a mounting pedestal.

4. The eight-drive six-degrees-of-freedom electrodynamic vibration testing apparatus having the adjustable spatial pose according to claim 3, wherein an output end of the first supplementary coupling assembly is connected to an eighth double-spherical-coupling decoupling apparatus, and an output end of the first shaker is connected o a first double-spherical-coupling decoupling apparatus; an output end of the second supplementary coupling assembly is fixedly connected to a second double-spherical-coupling decoupling apparatus, and an output end of the second shaker is connected to a third double-spherical-coupling decoupling apparatus; an output end of the third supplementary coupling assembly is connected to a fourth double-spherical-coupling decoupling apparatus, and an output end of the third shaker is connected to a fifth double-spherical-coupling decoupling apparatus; and an output end of the fourth supplementary coupling assembly is fixedly connected to a sixth double-spherical-coupling decoupling apparatus, and an output end of the fourth shaker is connected to a seventh double-spherical-coupling decoupling apparatus.

5. The eight-drive six-degrees-of-freedom electrodynamic vibration testing apparatus having the adjustable spatial pose according to claim 4, wherein an output end of the fifth shaker is connected to a ninth double-spherical-coupling decoupling apparatus, an output end of the sixth shaker is connected to a tenth double-spherical-coupling decoupling apparatus, an output end of the seventh shaker is connected to an eleventh double-spherical-coupling decoupling apparatus, and an output end of the eighth shaker is connected to a twelfth double-spherical-coupling decoupling apparatus.

6. The eight-drive six-degrees-of-freedom electrodynamic vibration testing apparatus having the adjustable spatial pose according to claim 5, wherein a working platform is fixed among the first double-spherical-coupling decoupling apparatus, the second double-spherical-coupling decoupling apparatus, the third double-spherical-coupling decoupling apparatus, the fourth double-spherical-coupling decoupling apparatus, the fifth double-spherical-coupling decoupling apparatus, the sixth double-spherical-coupling decoupling apparatus, the seventh double-spherical-coupling decoupling apparatus, the eighth double-spherical-coupling decoupling apparatus, the ninth double-spherical-coupling decoupling apparatus, the tenth double-spherical-coupling decoupling apparatus, the eleventh double-spherical-coupling decoupling apparatus, and the twelfth double-spherical-coupling decoupling apparatus through a double hydrostatic spherical-coupling base.

7. The eight-drive six-degrees-of-freedom electrodynamic vibration testing apparatus having the adjustable spatial pose according to claim 6, wherein the double hydrostatic spherical-coupling base comprises a spherical-coupling base body, a first movable body movably installed inside the spherical-coupling base body, and a second movable body movably installed inside the spherical-coupling base body.

8. The eight-drive six-degrees-of-freedom electrodynamic vibration testing apparatus having the adjustable spatial pose according to claim 3, wherein each of the first supplementary coupling assembly, the second supplementary coupling assembly, the third supplementary coupling assembly, and the fourth supplementary coupling assembly comprises a supplementary coupling assembly drive airbag, a supplementary coupling assembly bearing seat, a supplementary coupling assembly guide bearing, a supplementary coupling assembly guide bearing cover, a supplementary coupling assembly guide shaft, and a supplementary coupling assembly connecting flange.

9. The eight-drive six-degrees-of-freedom electrodynamic vibration testing apparatus having the adjustable spatial pose according to claim 8, wherein the supplementary coupling assembly guide shaft is slidably connected to the supplementary coupling assembly guide bearing, the supplementary coupling assembly guide bearing and the supplementary coupling assembly guide bearing seat are fixedly installed through the supplementary coupling assembly guide bearing cover, and the supplementary coupling assembly connecting flange is fixedly welded to the supplementary coupling assembly guide shaft.

10. The eight-drive six-degrees-of-freedom electrodynamic vibration testing apparatus having the adjustable spatial pose according to claim 3, wherein The first shaker and the third shaker vibrate at the same frequency and in the same phase at the same time, so that the linear vibration of a working platform is achieved along an x axis; the second shaker and the fourth shaker vibrate at the same frequency and in the same phase at the same time, so that the linear vibration of the working platform is achieved along the y axis

11. The eight-drive six-degrees-of-freedom electrodynamic vibration testing apparatus having the adjustable spatial pose according to claim 3, wherein a manner of achieving a three-axis linear vibration is as follows:
the first shaker and the third shaker on an x axis are controlled to vibrate according to a specified vibration waveform, and the vibration control of the first shaker and the third shaker requires the same frequency and phase at the same time; the second shaker and the fourth shaker on a y axis are controlled to vibrate according to a specified vibration waveform, and the vibration control of the second shaker and the fourth shaker requires the same frequency and phase at the same time; and the fifth shaker, the sixth shaker, the seventh shaker, and the eighth shaker on a z axis are controlled to vibrate according to a specified vibration waveform, and the vibration control of the fifth shaker, the sixth shaker, the seventh shaker, and the eighth shaker requires the same frequency and phase at the same time, so that the linear vibrations of x, y, and z axes are synthesized into a spatial three-axis linear vibration at a working platform.

12. The eight-drive six-degrees-of-freedom electrodynamic vibration testing apparatus having the adjustable spatial pose according to claim 3, wherein a manner of achieving a three-axis angular vibration is as follows:
the first shaker and the third shaker are controlled to vibrate according to a specified vibration waveform, and the vibration control of the first shaker and the third shaker requires the same frequency and phase at the same time, thereby forming an angular vibration around a z axis; the second shaker and the fourth shaker are controlled to vibrate according to a specified vibration waveform, and the vibration control of the second shaker and the fourth shaker requires the same frequency and phase at the same time, thereby forming an angular vibration around the z axis; the fifth shaker and the eighth shaker are controlled to vibrate according to a specified vibration waveform, and the vibration control of the fifth shaker and the eighth shaker requires the same frequency and phase at the same time, and meanwhile, the sixth shaker and the seventh shaker are controlled to vibrate according to a specified vibration waveform, and the vibration control of the fifth shaker and the eighth shaker requires the same frequency and inverse phase at the same time, thereby forming an angular vibration around a y axis; or the fifth shaker and the sixth shaker are controlled to vibrate according to a specified vibration waveform, and the vibration control of the fifth shaker and the sixth shaker requires the same frequency and phase at the same time, and meanwhile, the seventh shaker and the eighth shaker are controlled to vibrate according to a specified vibration waveform, and the vibration control of the fifth shaker and the eighth shaker requires the same frequency and inverse phase at the same time, thereby forming an angular vibration around an x axis, so that the angular vibrations of x, y, and z axes are synthesized into a spatial three-axis angular vibration at a working platform.

13. The eight-drive six-degrees-of-freedom electrodynamic vibration testing apparatus having the adjustable spatial pose according to claim 6, wherein the double-spherical-coupling decoupling apparatus is a hydrostatic lubrication decoupling apparatus, a mechanical lubrication decoupling apparatus, or a spherical-planar decoupling apparatus.
